(19) United States
(12) Patent Application Publication
(10) Pub. No.: US 2026/0220468 A1
(43) Pub. Date: Jul. 30, 2026

(54) JOINT LEARNING OF PROBABILISTIC ENERGY-BASED MODELS AND THEIR PARTITION FUNCTIONS

(71) Applicant: GDM Holding LLC, Mountain View, CA (US)

(72) Inventors: Mathieu Etienne Gerard Blondel, l'Etang-la-ville (FR); Vincent Michel Roulet, Seattle, WA (US); Michaël Eli Sander, Paris (FR); Tianlin Liu, Paris (FR)

(21) Appl. No.: 19/465,972

(22) Filed: Jan. 30, 2026

Related U.S. Application Data
(60) Provisional application No. 63/751,663, filed on Jan. 30, 2025.

(51) Int. Cl. G06N 3/084

(52) U.S. Cl. CPC G06N 3/084

(57) ABSTRACT

A computer implemented method for training a probabilistic energy-based model. The method comprises: obtaining an energy model configured to parameterize, based on a first set of parameters, an energy function of the probabilistic energy-based model to determine an energy score associated with a combination of an input and an output; obtaining a normalization neural network configured to parameterize, based on a second set of parameters, a normalization factor of the probabilistic energy-based model; and jointly training the energy model and the normalization neural network by minimizing a loss function that is dependent on the energy score determined by the energy model and the normalization factor determined by the normalization neural network.

### CROSS-REFERENCE TO RELATED APPLICATIONS

This application claims priority to U.S. Provisional Application No. 63/751,663 filed on Jan. 30, 2025. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This application provides a solution to the efficient implementation of probabilistic energy-based models based on utilizing an energy model for parameterizing the energy function of the probabilistic energy-based model and a normalization neural network for parameterizing the normalization function (e.g. the partition function) of the probabilistic energy-based model. By modelling the normalization function via a normalization neural network, the probabilistic energy-based model can be implemented and trained efficiently (e.g. via gradient descent). This overcomes issues, particularly with regard to training, where the normalization function can be intractable over large output spaces. The methods described herein can be implemented on a variety of architectures and using a variety of loss functions, including loss functions in the Fenchel-Young loss function family.

According to an aspect there is provided a computer implemented method for training a probabilistic energy-based model, the method comprising: obtaining an energy model configured to parameterize, based on a first set of parameters, an energy function of the probabilistic energy-based model to determine an energy score associated with a combination of an input and an output; obtaining a normalization neural network configured to parameterize, based on a second set of parameters, a normalization factor of the probabilistic energy-based model; and jointly training the energy model and the normalization neural network by minimizing a loss function that is dependent on the energy score determined by the energy model and the normalization factor determined by the normalization neural network.

The energy model may comprise a neural network. For instance, the energy model may comprise (e.g., may be) a first neural network and the normalization neural network may comprise (e.g., may be) a second neural network. The energy model may make use of a coupling function. The coupling function may determine an energy score based on the output and based on an output of the first neural network. For instance, the first neural network may process the input to produce one or more parameters (e.g., logits) and the coupling function may determine the energy score based on the one or more parameters and the output.

The normalization neural network may parameterize a normalization function that includes a sum or integral of probabilities across output space. The normalization neural network may parameterize the normalization factor of the probabilistic energy-based model. This can ensure that probabilities determined by the probabilistic energy-based model integrate or sum to 1 across output space. The normalization function may be otherwise known as a partition function of the probabilistic energy-based model. In one example, the normalization neural network may parameterize a log of the normalization factor of the probabilistic energy-based model. In this case, the normalization function may be known as a log-partition function. By jointly training the energy model and the normalization neural network, the probabilistic energy-based model can be trained efficiently (e.g. through stochastic gradient descent), without having to resort to complicated methods, such as the Markov Chain Monte Carlo (MCMC) method. Furthermore, the normalization function can be trained to generalize to unseen input-output pairs.

According to an implementation the loss function comprises a first term and a second term, wherein the first term comprises an expectation with respect to inputs and outputs of the energy score output by the energy model, and the second term comprises the expectation with respect to inputs of a normalization term. The normalization term may comprise the normalization factor output by the normalization neural network and a sum or integral of probabilities determined using the energy model and the normalization neural network according to the probabilistic energy-based model as determined based on output values sampled from a prior measure.

According to a further aspect there is provided a computer implemented method for predicting a probability of an output based on an input using a probabilistic energy-based model, the method comprising: obtaining an energy model configured to parameterize, based on a first set of parameters, an energy function of the probabilistic energy-based model to determine an energy score associated with a combination of an input and an output; obtaining a normalization neural network configured to parameterize, based on a second set of parameters, a normalization factor of the probabilistic energy-based model; and determining the probability of the output based on the input according to the probabilistic energy-based model. Determining the probability comprises: determining an energy score using the energy model based on the input and the output; and determining the probability based on the energy score, wherein the probability is normalized using a normalization value obtained from the normalization neural network based on the input.

According to an implementation, the method further comprises determining a predicted output based on the probability determined according to the probabilistic energy-based model. For instance, the predicted output may be the output that that maximizes the probability determined according to the probabilistic energy-based model. According to an implementation, the method further comprises outputting the predicted output. According to an implementation the predicted output is a mean or expected output given a particular input.

According to an implementation the method further comprises training a further model based on the determined probability, wherein the output is an output from the further model based on the input. Accordingly, the probability (or a probability distribution of the probabilistic energy-based model) may be used to train a further model (e.g. a further neural network model). For instance, the further model can determine the output based on the input, and the input output pair can be provided to the probabilistic energy-based model to assess the affinity between the input and the output (e.g. the accuracy the output). This can then be used as feedback to train the further model. For instance, the probability may be, or may form part of, a reward (e.g. a reward may be based on the probability), which can then be used to train the further model (e.g. via reinforcement learning). For instance, the probabilistic energy-based model may be a reward model (e.g. forming part of a reinforcement learning from human feedback system). The training may comprise fine tuning the further model (e.g. additional training following initial training).

According to a further implementation, there is provided a method comprising training an energy model of a probabilistic energy-based model using methods described herein, and then using the trained energy model to determine an energy score for an input and an output. The training may comprise joint-training with the normalization neural network. That is, some use-cases may not require the normalization neural network during inference. Instead, the energy score may be utilized without requiring normalization. For instance, the energy score may be used to train a further model (e.g. as a reward). Alternatively or in addition the energy score may be used to select an output (e.g. an action that optimizes the energy score).

According to a further implementation, the normalization neural network is configured (e.g., trained) to generalize to unseen inputs not present in a training dataset, such that the normalization factor for a new input can be determined by a forward pass of the trained normalization neural network. This may be achieved without recalculating a sum or integral over the output space.

Particular implementations of the subject matter described in this specification can be implemented so as to realize one or more of the following advantages.

The implementations provide a technique for effectively modelling a probabilistic energy-based model using an energy model for the energy function and a normalization neural network for the normalization function. This allows the two models to be jointly trained, allowing the model to be trained in polynomial time. This allows the training to be tractable for large output spaces, thereby overcoming a major limitation previously seen in probabilistic energy-based models. The methods described herein can be applied to any type of neural network (there is no constraint to the type of neural networks that are used). Furthermore, only two neural networks need to be learned for use in inference.

In addition, by modelling the normalization function using the normalization neural network, the normalization factor (e.g. the log partition function) can be determined even for unseen data points. By utilizing a neural network to parameterize the normalization factor, the system gains the ability to estimate the normalization factor for input-output pairs not present in the training data. This leverages the universal approximation properties of the normalization neural network to provide fast, real-time probabilistic estimates for unseen data points, a significant improvement over simple vector-based parameterizations that cannot generalize beyond a fixed training set.

In some implementations, the joint training of the energy model and the normalization neural network is performed across a distributed computing architecture. Specifically, the energy model and the normalization neural network may be implemented on, and executed by, separate and distinct hardware components. For example, the energy model may be instantiated on a first set of hardware accelerators (e.g., a first cluster of GPUs or TPUs), while the normalization neural network is instantiated on a second, distinct set of hardware accelerators. These distinct hardware components may possess different computational characteristics or memory capacities tailored to the specific requirements of each model; for instance, the energy model hardware may be optimized for high-throughput processing of large input-output pairs, while the normalization neural network hardware may be optimized for rapid iterative updates of the log-partition function. During joint training, the first and second sets of hardware may communicate gradients, parameters, or intermediate outputs (such as energy scores or normalization values) via a high-speed interconnect or data bus. This decoupled hardware execution allows for parallelization of the energy and normalization computations, reducing the overall training latency and enabling the system to scale to significantly larger parameter spaces or more complex prior measures than would be feasible on a single hardware unit.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow diagram of an example method for predicting an output using a probabilistic energy-based model.

FIG. 2 is a block diagram of an example system for calculating a probability of an output based on an input using a probabilistic energy-based model.

FIG. 3 is a flow diagram of an example method 300 for jointly training an energy model and a normalization neural network.

Like reference numbers and designations in the various drawings indicate like elements.

### DETAILED DESCRIPTION

The implementations described herein relate to training and implementing machine learning models, specifically probabilistic energy-based models (EBMs). The systems and methods described herein provide a computationally efficient solution for parameterizing and training these models in complex output spaces where traditional methods, such as those relying on Markov Chain Monte Carlo (MCMC), are computationally prohibitive.

A probabilistic energy-based model may determine a probability based on an affinity (e.g. a compatibility) between an input and an output. The affinity between an input and an output may be related to an energy value associated with the input and output. A probabilistic energy-based model can be defined as:

$$p ( y \vert x ) = \frac{q ( y \vert x ) exp ( - E ( x , y ) )}{Z}$$

where
p(y|x) is the probability of output y given input x according to the probabilistic energy-based model;
q(y|x) is the probability of output y given input x according to a prior measure;
E(x,y) is an energy value for the input x and output y; and
Z is a normalization factor.

The probabilistic energy-based model can be trained to assign lower energy values to input output pairs that have a stronger affinity.

The prior measure q(⋅|x) (otherwise known as a reference measure) can be selected depending on the task being modelled. The prior measure q(⋅|x) may be a prior conditional positive measure. If the prior measure is not known, a uniform positive measure (e.g. a uniform positive distribution) can be used. The prior measure may be a prior distribution.

The assignment of energy scores can be parameterized through the use of an energy model g(x,y):

$$p ( y \vert x ) = \frac{q ( y \vert x ) exp ( g ( x , y ) )}{Z}$$

The energy model g(x,y) is configured to assign an energy score to an input and an output. In this case, the energy score is the negative of the energy value for the input and output, but in alternative implementations, the energy score is the energy value, and the probability is determined by taking the negative of the energy score. The energy model g(x,y) may be configured to parameterize the energy function using a first set of parameters w. The energy model may be an energy model neural network. The first set of parameters w may be parameters (e.g., weights) of the energy model neural network.

During inference, a predicted output y*(x) may be determined for a given input x based on the probability distribution p(⋅|x) according to that input x. For instance, a mode of the learned probability distribution may be calculated. That is, a predicted output y*(x) may be determined that has the maximum probability given the probability distribution (e.g. that maximises p(⋅|x)):

$$y * ( x ) = {argmax}_{y ∈ 𝒴} p ( y \vert x )$$

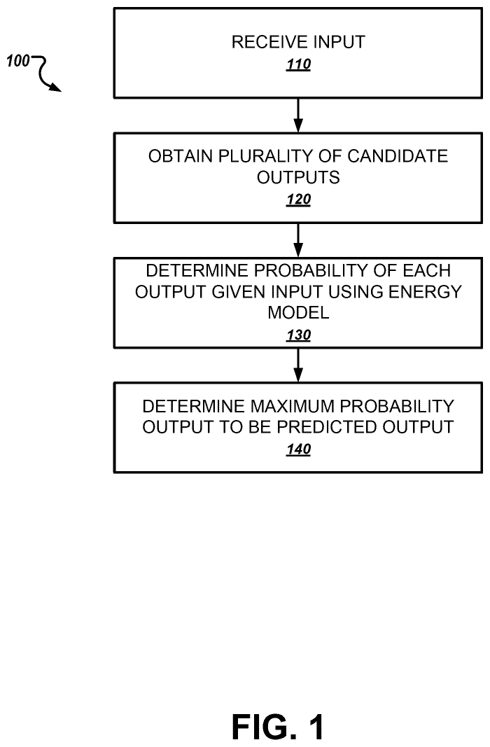

FIG. 1 is a flow diagram of an example method 100 for predicting an output using a probabilistic energy-based model. An input is received 110. The input 110 may be input by a user, accessed from memory, or received from an external device or system. A plurality of candidate outputs are obtained 120. The candidate outputs may be input by a user, accessed from memory, received from an external device or system or generated by the system (e.g., generated by a further neural network or sampled from a distribution). The probability of each output given the input is then determined using the energy model 130. The method then determines (e.g., selects) the output that has the largest probability out of the plurality of candidate outputs to be the predicted output 140.

As the determination of the predicted output includes a determination of the maximum probability, the determination of the mode can be implemented without normalization of the probabilities (e.g., without calculating Z).

As an alternative to predicting a single output, the probabilistic energy-based model can be used to rank outputs (e.g., in order of probability, given a particular input). Again, as the probabilities are ranked relative to each other for a given input, this can be achieved without normalization of the probabilities (e.g., without calculating Z).

Having said this, training a probabilistic energy-based model can often be intractable for large output spaces due to the normalization factor Z which can require summing over output space [symbol] :

$$Z = {\sum }_{{y}^{′} ∈ 𝒴} q ( {y}^{′} \vert x ) exp ( g ( x , {y}^{′} ) )$$

where y′ is a sampled output that is sampled using a prior measure q(y′|x) based on the input x.

For instance, to perform maximum likelihood estimation (MLE), Markov chain Monte Carlo (MCMC) methods may be used to estimate stochastic gradients of the log-likelihood function. However, an MCMC sampler may need to be derived on a case-by-case basis. Furthermore, in practice, MCMC iterations may not be run to convergence, leading to biased stochastic gradient estimates. In continuous spaces, score matching may be used as an alternative to MLE but it requires computing the Laplacian operator, which is challenging in high dimension. In combinatorially-large discrete spaces, the generalized perceptron loss or the generalized Fenchel-Young loss can be used, which only involve computing an argmax or a regularized argmax, respectively. These losses sidestep computing the partition function, but they learn non-probabilistic EBMs.

To overcome the above issues, implementations parameterize the normalization function (otherwise known as the partition function) for calculating the normalization factor. A normalization model is used to parameterize the normalization function based on a second set of parameters v. The normalization model may be a normalization neural network τ(x). The second set of parameters y may be parameters (e.g., weights) of the normalization neural network τ(x). The normalization neural network may output a normalization value.

Specifically, the normalization neural network may parameterize the log of the normalization factor:

$$τ ( x ) = log {\sum }_{{y}^{′} ∈ 𝒴} q ( {y}^{′} \vert x ) exp ( g ( x , {y}^{′} ) )$$

That is, the normalization value may be the log of the normalization factor Z. The output of the normalization neural network (the normalization value) may be otherwise known as the log-sum-exp (LSE) as it is a log of a sum of an exponential. The sum for the normalization neural network may be implemented over a plurality of sampled outputs y′ that are sampled using a prior measure q(y′|x) based on the input x.

The normalization neural network allows the probability to be calculated as:

$$p ( x \vert y ) = q ( y \vert x ) exp ( g ( x , y ) - τ ( x ) ) .$$

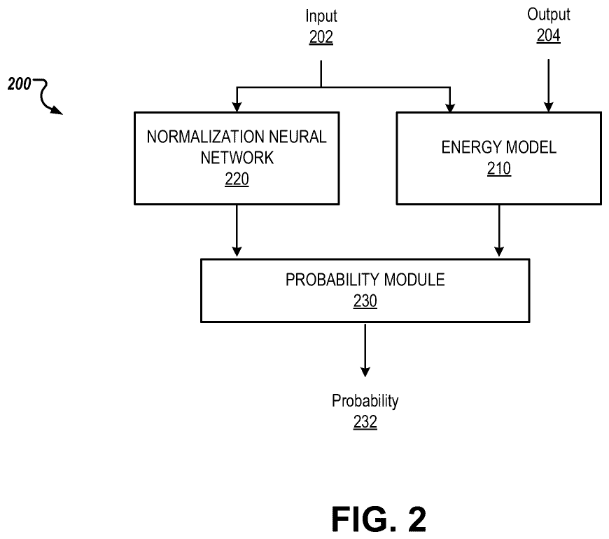

FIG. 2 is a block diagram of an example system 200 for calculating a probability of an output 204 based on an input 202 using a probabilistic energy-based model 210. The system 200 is configured to obtain the input 202 and output 204. The input 202 and output 204 may be obtained through sampling, received as a user input, accessed from memory or received from an external device or system. In one example, the system 200 may receive an input 202 and may obtain a plurality of outputs 204 for which probabilities are to be determined. The system may determine the probability of each output 204 based on the input 202.

The input 202 and output 204 are input into the energy model 210 to determine an energy score (e.g., the negative of the energy value). The input 202 is input into the normalization neural network 220 to determine a normalization value (e.g., the log of the normalization factor Z).

A probability module 230 then uses the energy score and the normalization value to determine the probability 232 of the output 204 based on the input 202 (e.g., the probability of the input-output pair). The probability 232 may be a normalized probability.

The probabilistic energy-based model can be trained by jointly learning the energy model and the normalization neural network. This can be achieved without the use of MCMC methods, and can be applied to combinatorially large output spaces. The output space may be discrete. The input space may be continuous.

In the present method, the log-partition function may be treated as an optimization variable within a joint learning framework. By formulating the normalization factor as a function τ∈ [symbol] ( [symbol] ) to be minimized over, the intractable equality constraint of the partition function is transformed into a tractable component of the neural network architecture.

The normalization function can be formulated as an (intractable) equality constraint: [symbol] p_{g}(y|x)=1 or [symbol] p_{g}(y|x)=1 for all x∈ [symbol] . To manage this constraint, the normalization neural network can be introduced as a Lagrange multiplier which can be treated as a separate function to minimize over.

Accordingly, the normalization neural network may parameterise a Lagrange multiplier (e.g. a dual variable Lagrange multiplier) corresponding to an equality constraint that specifies that the probabilities determined by the probabilistic energy-based model integrate or sum to 1 across output space (e.g. [symbol] p_{g}(y|x)=1 or [symbol] p_{g}(y|x)=1).

In the case of maximum likelihood estimation with logistic loss, the Lagrange multiplier exactly coincides with the log-partition function of the probabilistic energy-based model.

In light of the above, the probabilistic energy-based model can be trained by jointly training the energy model and the normalization neural network. For instance, the training process may minimize a loss function that is dependent on both the energy score and the normalization factor.

According to an implementation, jointly training the energy model and the normalization neural network is performed through gradient descent (e.g. stochastic gradient descent). Jointly training the energy model and the normalization neural network may comprise minimizing the loss function with respect to the first set of parameters w (that parameterize the energy model) and the second set of parameters v (that parameterize the normalization neural network). For instance, the minimization may be:

$${min}_{w ∈ W} {min}_{v ∈ V} ℒ ( g , τ )$$

where
[symbol] (g,τ) is the loss function based on the energy model g and the normalization neural network τ;
w represents the first set of parameters from parameter space W; and
v represents the second set of parameters from parameter space V.

The use of a min min formulation allows the probabilistic energy-based model to be trained more efficiently, as min min formulations are easier to optimize than min max formulations. Unlike min-max adversarial formulations, which often require a score function estimator (e.g., REINFORCE) for gradients and consequently suffer from high variance, the present min-min formulation allows for easy computation of gradients. Because the expectations are taken with respect to a fixed prior q rather than an evolving model distribution p, the optimization process is significantly more stable and computationally efficient.

Specifically, the loss function [symbol] _{ƒ}(g, τ) may be:

$${ℒ}_{f} ( g , τ ) = {𝔼}_{x} [ {L}_{g , τ}^{f} ( x ) ] - {𝔼}_{( x , y )} [ g ( x , y ) ]$$

where

$${L}_{g , τ}^{f} ( x )$$

is the normalization term. The normalization term is called this as it incorporates outputs from the normalization neural network, but it may be otherwise referred to as a further term. The normalization term can be calculated for a given input by sampling outputs from the prior measure q(⋅|x).

The normalization term may be generally given by:

$${L}_{g , τ}^{f} ( x ) = τ ( x ) + {\sum }_{{y}^{′} ∈ 𝒴} q ( {y}^{′} \vert x ) {f}_{+}^{*} ( ( g ( x , {y}^{′} ) - τ ( x ) )$$

where
τ(x) is the normalization factor output by the normalization neural network and based on the input x;
q( ) is a prior measure;
g(x, y′) is an energy score output by the energy model based on the input x and an output y′ (e.g. a candidate output y′ sampled from output space [symbol] according to the prior measure q( ));

$${f}_{+}^{*}$$

( ) is the convex conjugate of ƒ₊( ) which is the restriction of ƒ( ) to positive real values; and
ƒ( ) is a generator function of an f-divergence used to determine a probability distribution according to the probabilistic energy-based model.

The normalization term can be determined based on output values y′ that are sampled for the input x according to the prior measure q(y′|x). Accordingly, the sum of the normalization term can be implemented over a batch of output values that are sampled based on the prior measure q(y′|x). For instance, the batch size for sample the outputs y′ may be m, where m is an integer.

The loss can be determined according to a finite number n of input-output pairs (x₁, y₁), (x₂, y₂), . . . (xₙ>yₙ) based on:

$$\text{?} ( g , τ ) = \frac{1}{n} {\sum }_{i = 1}^{n} {L}_{g , τ}^{f} ( {x}_{i} ) - g ( {x}_{i} , {y}_{i} )$$

n may be an integer that is the same as or different from m.

The probability distribution

$${p}_{g}^{f} ( \cdot \vert x )$$

according the probabilistic energy-based model may represented by:

$${p}_{g}^{f} ( \cdot \vert x ) = {argmax}_{p ∈ {P}_{1} ( 𝒴 )} 〈 g ( x , \cdot ) , p 〉 - {D}_{f} ( p , q ( \cdot \vert x ) )$$

where
D_{ƒ}(p, q(⋅|x)) is the f-divergence between the prior measure q( ) and a first probability distribution p taken from a space of probability distributions P₁( [symbol] ).

The probability

$${p}_{g}^{f}$$

(y|x) of the output y based on the input x is then given by:

$${p}_{g}^{f} ( y \vert x ) = q ( y \vert x ) {( {f}_{+}^{*} )}^{′} ( g ( x , y ) - τ ( x ) ) .$$

The formulation described herein naturally generalizes to the broader family of Fenchel-Young losses. This is a generalised formulation based on any type of f-divergence. Specific implementations are provided below for different divergences, such as chi-square divergence and Kullback-Leibler divergence. This allows the methodology described herein to be applied to a variety of losses within the Fenchel-Young family, such as logistic loss and sparsemax loss.

In the present application, parameters or functions with the subscript or superscript ƒ refer to the generalized Fenchel-Young loss, whereas parameters or functions without the subscript or superscript ƒ may refer to more specific implementations, such as logistic loss or sparsemax loss.

A Fenchel-Young loss may be defined as:

$$ℒ ( θ ; y ) = Ω * ( θ ) + Ω ( y ) - 〈 θ , y 〉$$

where
y∈ [symbol] is an output (e.g. a ground truth output);
θ is a vector of predicted scores (e.g., logits) from the model being trained;
Ω is a convex function (a regularization function); and
Ω* is the convex conjugate (otherwise known as Fenchel conjugate) of Ω.

The Fenchel-Young loss evaluates the discrepancy between the predicted scores θ and the target y in a way that depends on the choice of Ω. By changing the choice of Ω, different types of loss within the Fenchel-Young loss family may be obtained. In the present context, different normalization terms may be determined for different loss functions by assigning different types of f-divergence.

In one implementation, the f-divergence is a chi-square divergence and the loss function is a sparsemax loss function. In this implementation, the normalization term L_{g,τ}(x) is given by:

$${L}_{g , τ} ( x ) = τ ( x ) + \frac{1}{2} {\sum }_{{y}^{′} ∈ 𝒴} {q ( {y}^{′} \vert x ) [ g ( x , {y}^{′} ) - τ ( x ) ]}_{+}^{2}$$

where [ ]₊ denotes the non-negative part, and the probability is given by:

$${p}_{g} ( y \vert x ) = {q ( y \vert x ) [ g ( x , y ) - τ ( x ) ]}_{+}$$

and where y′ is a sampled output based on the prior measure q(⋅|x) for the input x.

To our knowledge, this provides the first tractable method for optimizing the sparsemax loss.

In another implementation, the f-divergence is a Kullback-Leibler divergence and the loss function is a maximum likelihood estimation (MLE) loss function. In this implementation, the normalization term L_{g,τ}(x) is given by:

$${L}_{g , τ} ( x ) = τ ( x ) + {\sum }_{{y}^{′} ∈ 𝒴} q ( {y}^{′} \vert x ) ( exp ( g ( x , {y}^{′} ) - τ ( x ) ) - 1 )$$

where
y′ is a sampled output based on the prior measure q(⋅|x) for the input x.

By including the −1 term, the objective function is structured such that when the learned normalization τ(x) perfectly estimates the true normalization function (e.g., the true log-partition function), the sum term equals zero (because

[symbol]

q(y′|x)(exp (g(x,y′)−τ(x))) becomes 1). This provides a stable training signal where the loss is anchored around the true likelihood.

Alternatively, the normalization term for the maximum likelihood estimation (MLE) implementation, the normalization term L_{g,τ}(x) may be given by:

$${L}_{g , τ} ( x ) = τ ( x ) + {\sum }_{{y}^{′} ∈ 𝒴} q ( {y}^{′} \vert x ) exp ( g ( x , {y}^{′} ) - τ ( x ) )$$

where
y′ is a sampled output based on the prior measure q(⋅|x) for the input x.
   This provides an alternative implementation for certain optimization regimes. While the version including the −1 term may be preferable for training stability as it anchors the loss around the true likelihood, both formulations allow the joint training process to converge toward the optimal log-partition function.

The probability distribution p_{g}(⋅|x) for Kullback-Leibler divergence implementation (MLE loss) may be represented by:

$${p}_{g} ( \cdot \vert x ) = {argmax}_{p ∈ {P}_{1} ( 𝒴 )} 〈 g ( x , \cdot ) , p 〉 - K L ( p , q ( \cdot \vert x ) )$$

where
KL(p,q(⋅|x)) is a Kullback-Leibler divergence between the prior measure q( ) and a first probability distribution p taken from a space of probability distributions P₁( [symbol] ).

More specifically, the probability of a given output y for a given input x in the MLE implementation may be calculated as:

$${p}_{g} = q ( y \vert x ) exp ( g ( x , y ) - τ ( x ) )$$

Regardless of the form of loss used, the energy model and the normalization neural network can be jointly trained using the appropriate loss function (discussed above), for instance, through gradient descent.

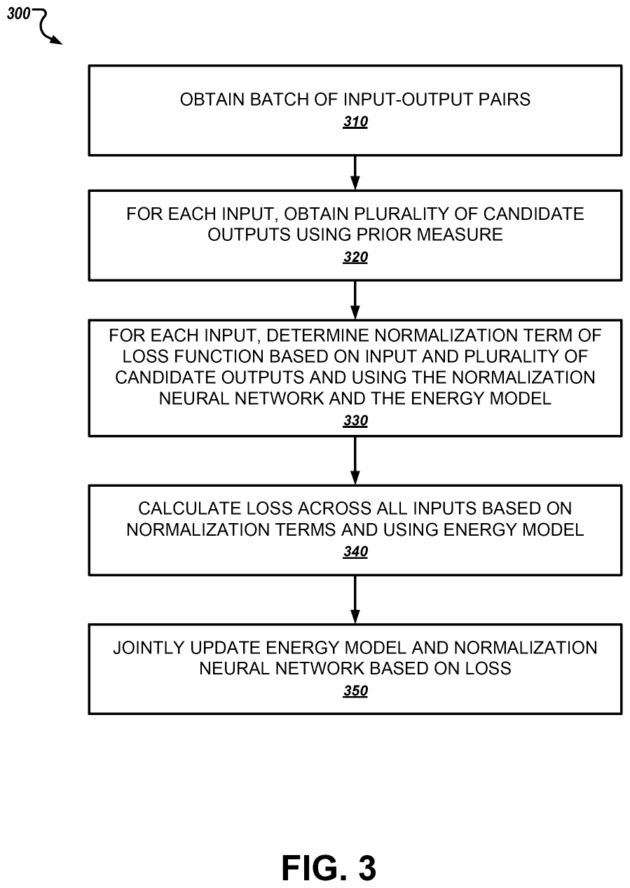

FIG. 3 is a flow diagram of an example method 300 for jointly training an energy model and a normalization neural network.

A batch of input-output pairs is obtained 310. Each input-output pair may comprise an input and a corresponding output. The input-output pairs may be obtained (e.g., sampled) from a training dataset. The number of input-output pairs in the batch may be a first batch size B.

For each input (e.g., for each input-output pair) in the batch, a plurality of candidate outputs is obtained using a prior measure 320. For instance, the input may be input into a prior distribution which can then be used to sample a plurality of candidate outputs. The number of candidate outputs for each input may be a second batch size B′. The second batch size B′ may be the same or different to the first batch size B.

For each input (e.g., for each input-output pair), a normalization term L_{g,τ}(x) for the loss function is determined based on the input and the plurality of candidate outputs for that input 330. The normalization term L_{g,τ}(x) is determined using the normalization neural network and the energy model. The normalization term L_{g,τ}(x) may be calculated according to any of the methods described herein. The calculation of the normalization term L_{g,τ}(x) may involve determining the normalization value output by the normalization neural network based on the input, and may involve determining, for each candidate output, an energy value using the energy model based on the input and the candidate output. The normalization term L_{g,τ}(x) may be calculated by summing over the energy values for the input and the candidate outputs.

The loss [symbol] (g,τ) is then calculated across all inputs in the batch based on the normalization terms and using the energy model. The loss [symbol] (g,τ) may be calculated using any of the methods described herein. The calculation of the loss [symbol] (g,τ) may include subtracting the expected energy score (calculated using the energy model) across input-output pairs from the expected normalization term across inputs.

The energy model and normalization neural network are then jointly updated based on the loss [symbol] (g,τ). For instance, the parameters of the energy model and normalization neural network may be updated using stochastic gradient descent.

The method 300 may be repeated over a number of training iterations. For instance, the method 300 may be repeated until an end criterion is met. For instance, the end criterion may include one or both of a predefined performance is met, or a predefined maximum number of training iterations have been performed.

Algorithm 1 provides pseudo-code for the calculation of the maximum likelihood estimation (MLE) loss:

```
Algorithm 1 Doubly stochastic objective value computation
  Inputs: models g and τ, batch sizes B and B′
  $Draw ( {x}_{1} , {y}_{1} ) , … , ( {x}_{B} , {y}_{B} ) {\sim}^{i . i . d .} ρ𝓍 \times y$
  $Draw {y}_{i , 1}^{′} , … , {y}_{i , {B}^{′}}^{′} {\sim}^{i . i . d .} q ( \cdot \vert {x}_{i} ) for i ∈ [ B ]$
  ${\tilde{L}}_{g , τ} ( {x}_{i} ) := τ ( {x}_{i} ) + \frac{1}{{B}^{′}} {\sum }_{j = 1}^{{B}^{′}} ( exp ( g ( {x}_{i} , {y}_{i , j}^{′} ) - τ ( {x}_{i} ) ) - 1 )$
  $Output \text{:} \frac{1}{B} ( {\sum }_{i = 1}^{B} {\tilde{L}}_{g , τ} ( {x}_{i} ) - g ( {x}_{i} , {y}_{i} ) )$
```

The equations of Algorithm 1 can be adapted depending on the loss function that is being used.

According to an implementation the joint training includes obtaining a set of one or more input output pairs from training data (each input output pair comprising an input and a corresponding (e.g. ground truth) output). For each input, a set of one or more sampled outputs may be obtained using the prior measure. For each input, the normalization term is calculated based on the sampled outputs. The expected loss is then determined across training input output pairs. Whilst one specific implementation of the loss function is shown in Algorithm 1, any of the loss functions described herein may be utilized.

Algorithm 1 outputs the expected (e.g. mean) loss. This can then be used to update the parameters of the energy model and the normalization neural network to optimize (e.g. minimize) the loss (e.g. through back propagation). This can be achieved through stochastic gradient descent.

The methods described herein allow a probabilistic energy-based model to be trained more efficiently and with reduced bias. In particular, the normalization factor is parameterized using a neural network, avoiding the need to use Markov chain Monte Carlo (MCMC) methods, which may require an MCMC sampler to be derived on a case-by-case basis, and which can introduce biased estimates if not run to convergence.

In certain implementations, a coupling function Φ(θ, y) may be used to decompose the affinity between an input and an output. In this framework, a model function h(x) first processes the input x to produce a set of logits or natural parameters, denoted as θ. The coupling function then captures the compatibility between these produced logits and a candidate output y, such that the energy score g(x,y) is defined as Φ(h(x),y). That is, the coupling function generates the energy score based on the output of the model function h(x), and the output y.

A variety of different coupling functions can be applied. For instance, a bilinear coupling is Φ(θ,y):= [symbol] θ,y [symbol] . This coincides with standard exponential family distributions. Nevertheless, the methods described herein support more advanced non-bilinear couplings for more complex tasks.

For structured prediction tasks, the coupling function can be designed to handle combinatorially large discrete spaces by operating over a convex set C, which represents the convex hull of the output space [symbol] . For example, in multilabel classification, a linear-quadratic coupling may be employed to associate weights with individual labels and weights with pairwise label interactions. In label ranking implementations, the coupling function may be applied to vector representations within a permutahedron or matrix representations within a Birkhoff polytope. If the chosen coupling function is concave in its second variable, the most likely output can be predicted efficiently in polynomial time using gradient-based solvers or combinatorial algorithms like the Hungarian algorithm.

The energy model can be realized using various neural network architectures designed to extract meaningful features from the input data x. For instance, where the coupling function is being utilized, the model function h(x) may be implemented using any of a variety of different neural network architectures. For instance, a multilayer perceptron (MLP) architecture may be utilized. This may be suitable for general data processing. As another example, a residual network (ResNet) may be used. This may be suitable for scenarios involving high-dimensional or hierarchical data, such as image or video processing, to facilitate the learning of deep compatibility features. The system is architecture-agnostic, allowing for the integration of convolutional architectures, recurrent architectures, or attention-based architectures such as Transformers, depending on the specific modality of the input x. The output dimensionality of the chosen architecture can be configured to match the requirements of the task, and depending on whether the coupling function Φ(θ, y) is being utilized. For instance, in a label ranking task using a permutahedron representation, the architecture can produce a vector of logits θ∈ [symbol] ^{k} to assign weights to individual labels. Conversely, when utilizing a Birkhoff polytope representation for the same task, the architecture can be configured to output a matrix of natural parameters θ∈ [symbol] ^{k×k}, thereby enabling the model to capture and parameterize complex pairwise label interactions even when using linear or shallow model functions. By parameterizing with these expressive neural network structures, the energy-based model can benefit from universal approximation properties to learn highly nonlinear affinities between diverse inputs and combinatorially large output spaces.

In implementations of the training and inference methods described herein, the normalization neural network τ (also referred to as the log-partition network) can be parameterized using various neural network architectures to ensure efficient estimation of the normalization factor. For instance, a multilayer perceptron (MLP) or a residual network (ResNet) may be employed to learn the mapping from an input x to its corresponding normalization value. This can be suitable for standard supervised tasks. An advantage of using these deep architectures is that the learned normalization network benefits from universal approximation properties, enabling it to generalize effectively to unseen data points at inference time. Furthermore, the normalization neural network may be implemented as an Input-Convex Neural Network (ICNN). Utilizing an ICNN for τ is technically significant because it ensures that the function remains convex with respect to its inputs, which can provide additional mathematical guarantees and stability during the joint training process. This architecture choice is particularly relevant when the energy-based model is used in a “min-min” optimization setting, where joint training requires minimizing a loss function with respect to the parameters of both the energy model g and the normalization model τ. By parameterizing τ as an expressive neural network, the system can bypass the need for expensive and potentially biased Markov chain Monte Carlo (MCMC) sampling while still recovering optimal solutions.

The trained energy model can be used for a variety of tasks. For instance, the trained energy model can be used to predict a most probable output given an input. To simplify the calculation, instead of searching across all output space, the method can search over the convex hull of the output space.

For instance, the energy model can be used in a classification task (e.g., a multi-label classification task). As another example, the energy model can be used in an object detection task to identify the location(s) of one or more types of objects within an image or video.

As another example, the trained energy model can be used to rank input-output pairs in order of affinity/energy and/or probability. For instance, a list of labels can be ranked in order of relevance to an input.

As another example, the trained energy model can be used in permutation prediction. For instance, given an input, the trained energy model can predict a ranking of k labels represented as a permutation of labels. The output may be a permutation of labels (e.g., a list of labels in a particular order). For instance, the output may be a permutation of labels (l₁, . . . , lₖ), or a permutation of label identifiers (1, . . . , k). In such implementations, the output space can be combinatorially large with a cardinality of k!. To solve for the optimal permutation (the mode), the model may utilize a bilinear coupling between logits and the output representation. This representation may include a vector form, where the convex hull is the permutahedron, allowing the argmax to be solved optimally via an argsort operation. Alternatively, a permutation can be represented as a permutation matrix. For instance, the convex hull may be within the Birkhoff polytope (the set of doubly-stochastic matrices), where the optimal solution can be determined using the Hungarian algorithm.

Furthermore, the probabilistic energy-based model can be used to train another model. For instance, an output of a model based on an input can be assigned a score based on the output of the energy model given the input and output (the input-output pair). The score may be the energy score calculated for the input-output pair, or may be the probability (e.g., the normalized probability) calculated for the input-output pair. The score can be used to train the model. For instance, a loss can be calculated based on the score, and the loss can be used to train the model. Additional loss terms can be used, in addition to the loss based on the score.

For instance, the energy model can be used as a reward model in reinforcement learning (e.g., reinforcement learning from human feedback). The energy model can be used to determine the affinity between the input and the resulting output of the model being trained. For instance, the energy model can be used to train a generative neural network (e.g., a generative large language model), based on the compatibility between an input (e.g., a prompt) and an output generated by the generative neural network.

In one implementation, the input comprises one or more of image data, video data, audio data and sensor data and the output is a classification of the input. In one implementation the input comprises one or more of image data, video data, audio data and sensor data and the output is a list of labels ranked in order of relevance to the input. In one implementation, the input represents a state of a real-world environment and the output is an action to be performed by a mechanical agent operating in the real-world environment. In one implementation, the input comprises audio data representing a spoken utterance and the output is a text transcript for the utterance. In one implementation, the input comprises a natural language prompt and the output comprises image and/or audio data generated according to the natural language prompt. One or both of the input and output may be multimodal (e.g. may comprise two or more types of data, such as image data, video data, audio data, sensor data, natural language data, etc.).

In one implementation, the input comprises a natural language prompt and the output comprises natural language generated according to the natural language prompt. The output may be determined according to a task. The task may be included in the natural language prompt. The input may be multimodal. The input may include image data or video data. The task may include an open vocabulary image or video classification or object detection task. The natural language prompt may include a plurality of class descriptions or object descriptions and the task may include a request to rank the class descriptions or object descriptions. The ranking may be according to the accuracy of the class descriptions or object descriptions, or according to a described criterion (e.g. within the natural language prompt).

The models described herein can be applied to a variety of different use-cases based on a variety of different potential inputs and outputs. This can include classification, ranking, recommendation, action selection, and other use-cases, as detailed further below. The probabilistic energy-based model may comprise a neural network comprising the energy model (e.g. an energy neural network) and the normalization neural network. The probabilistic energy-based model may be configured to generate an output based on an input (e.g. by optimizing the probability or energy distribution). Alternatively, the probabilistic energy-based model may be used to provide training feedback to another model. The following description of use cases refer to a neural network and the different types of inputs, outputs and tasks that it could perform. The neural network referred to may be the probabilistic energy-based neural network (e.g. configured to generate an output), or may be a further neural network that is trained using the probabilistic energy-based model.

In general, the neural network may be configured to perform a task by predicting one or more outputs based on one or more inputs. As discussed above, where the neural network is the probabilistic energy-based neural network, the outputs may be predicated based on a probability distribution determined for the one or more inputs (e.g. by finding the output that maximizes the probability or optimizes the energy score).

The neural network can be trained to perform any kind of machine learning task, i.e., can be configured to receive any kind of digital data input and to generate any kind of score, classification, or regression output based on the input.

Some examples of machine learning tasks the neural network can be configured to perform follow. In implementations the neural network can be configured as, or include, a generative (large) language model or a multi-modal model, e.g., a visual and language model, to perform these example machine learning tasks.

In some cases, the neural network is a neural network that is configured to perform an image or video processing task, i.e., receive an input image or an input video having multiple frames (where each frame is an input image) and to process the intensity values of the pixels of the input image to generate a network output for the input image or the input video. The input image or an input video can be an image or video captured from the real-world.

For example, the task may be image classification and the output generated by the neural network for a given image may define a category of object represented in the image, e.g. may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image semantic segmentation and the output generated by the neural network can assign each pixel of the input image to a category from a set of categories. As yet another example, the task can be image instance segmentation and the output generated by the neural network can assign each pixel of the input image to a respective object instance from a set of object instances. As yet another example, the task can be image depth prediction and the output generated by the neural network can assign a respective predicted depth value to each pixel of the input image.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, the task is to rank potential labels in order of their relevance to the input. The output may therefore be a ranked list of labels ordered based on their relevance to the input. The input may be audio data, image data, video data, sensor data, or any other form of data.

As another example, if the input to the neural network is a sequence of text in one language, the output generated by the neural network may be a piece of text in the other language that is a predicted proper translation of the input text into the other language.

Some implementations may be used for automatic code generation. For example the input may represent words, wordpieces or characters in a first natural language, in particular describing a computer programming task, and the output may represent instructions in a computer programming or markup language, or instructions for controlling an application program to perform the task e.g. build a data item such as an image or web page.

As another example, the task may be an audio processing task. For example, if the input to the neural network is a sequence of audio data (for an audio waveform) representing a spoken utterance, the output generated by the neural network may be a text transcript for the utterance. As another example, the task may be a keyword spotting task where, if the input to the neural network is a sequence of audio data (for an audio waveform) representing a spoken utterance, the output generated by the neural network can indicate whether a particular word or phrase (“hotword”) was spoken in the utterance. As another example, if the input to the neural network is a sequence of audio data (for an audio waveform) representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input comprises physiological measurements and the output comprises a prediction that is relevant to the health of the patient. For example, the task can be determining the energy expenditure of a subject, where the input is data obtained from physiological sensors. In another example, the task can be deriving the body temperature of a subject, where the input is data obtained from an ear temperature detector. As another example, the task can be a medical diagnosis task, where the input comprises physiological measurements, and the output comprises information relating to a medical diagnosis.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., (pixels of) an image or a video, and the output can be text that describes the input. In some implementations the input represents data to be compressed, e.g. image data, video data, text data, audio data, or any other type of data; and the output a compressed version of the data. The input and output may each comprise any representation of the data to be compressed/compressed data e.g. symbols or embeddings generated/decoded by a respective neural network. A complementary neural network may perform the complementary task of data decompression.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g. a video camera system) may be provided for monitoring the action (if any) which the user actually performs at each time step, in case (e.g. due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv:2209.14375) or Chinchilla (Hoffmann et al. arXiv:2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and/or vice versa). Examples of such tasks include open-vocabulary image classification (the output can classify the image input based on a text input comprising text descriptions of one or more classes in the image), open-vocabulary object detection (the output can detect one or more objects in the image input based on a text input comprising text descriptions of the one or more objects), image captioning (the output can comprise text that describes the image input), text-based image search (the output can identify from amongst multiple images in the image input one or more images that meet a text description of images to be retrieved, the text description being provided in a text input), image-based retrieval (the output can identify from amongst multiple images in the image input one or more images that match an further image in the image input), and so on. Where the neural network is able to perform multiple different such tasks, the multi-modal processing task to be performed can be defined by text in a text input to the neural network.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

The tasks described above may be performed by the probabilistic energy-based model, or may be performed by another (e.g. further) model, where the probabilistic energy-based model forms part of a reward model for the further model. For instance, the further model may be a generative neural network system.

The generative neural network system may be configured to generate an output sequence by processing an input sequence using a sequence processing neural network.

The generative neural network system can comprise a large language model (LLM) or a vision-language model (VLM) that generates the output sequence in response to an input sequence that defines a “prompt” for the system.

In general a reward model defines a reward value (e.g. a scalar number) for a combination of an input sequence and a corresponding output sequence, e.g. that has been generated by the generative neural network system based on the input sequence. That is a reward model can process a combination of an input sequence and an output sequence to generate the reward value.

In implementations the reward model comprises a reward model neural network configured to process the input sequence and the corresponding output sequence to generate the reward value. One or more training inputs and one or more corresponding training outputs can be processed using the reward model to generate a respective one or more reward values, i.e. each reward value being obtained by processing the input and one of the corresponding outputs of a training example.

The reward model can be trained as described herein. For example a reward model can be obtained by training the model, e.g. a reward model neural network, using RLHF (Reinforcement Learning from Human Feedback), using human preferences obtained from human-labelled data. That is, the training data may be human-labelled data. Also or instead of using human-labelled data a reward model can be obtained using AI-feedback, e.g. from another LLM or VLM.

Implementations of the described techniques can obtain a set of training examples. Each training example comprises a training input sequence and a set of one or more corresponding training output sequences. A training example can be obtained by processing each training input sequence using the generative neural network system to generate each of the one or more corresponding training output sequences. The generative neural network system can be an earlier instance/version of the generative neural network system, i.e. one prior to the implementation of the described training (fine-tuning) method, that may be referred to as a baseline model.

The method described below can be performed for each training example; in implementations the training examples are grouped into batches for training the system.

The method involves processing a training example using a reward model to generate a respective reward value. In general the reward model has an objective, i.e. a system policy that it encourages when generating the output sequence, to favor characteristics of the generated sequence. The reward values generated by the reward model may measure compliance with characteristics of the training data.

The sequence processing neural network of the generative neural network system may be trained using the reward, i.e. using an objective function dependent on the reward.

In general training the sequence processing neural network may comprise backpropagating gradients of the objective function (with respect to the learnable parameters) to update the learnable parameters, e.g. weights, of the sequence processing neural network. This can use any appropriate gradient descent optimization algorithm, e.g. Adam or another optimization algorithm. Typically the gradients of the objective function are determined for a batch of training examples, and accumulated or averaged over the batch before performing an update step to update the learnable parameters.

In general a generative neural network system, in particular a sequence processing neural network, can have any appropriate architecture for generating an output sequence by processing an input sequence.

As one example, the generative neural network system (e.g. the sequence processing neural network), may comprise an auto-regressive generative model (e.g., a Transformer, a recurrent neural network, etc.) that can auto-regressively generate an output sequence as the output sequence based on the input. The generative neural network system can, for example, comprise a large language model (LLM) that can generate tokenized representations of text data; a vision-language model (VLM) that can generate tokenized representations of image or video data, e.g. in response to a text input or that can generate tokenized representations of text, e.g. in response to an image input; an audio model that can input or generate tokenized representations of audio data; or a multimodal model that can that can generate tokens representing any of text, image or audio, e.g. in response to an input comprising any of text, image or audio; and so on.

In some implementations the input(s) and the output(s), the training input(s) and the training output(s), each comprise token(s).

A “token” as used in this specification is a vector of numerical values having a specified dimensionality, i.e. the number of numerical values is constant across different tokens. Each token can comprise a respective predetermined or learned embedding (an ordered collection of numerical values having a pre-determined dimensionality.

In some implementations the tokens can represent text, e.g., words, wordpieces or characters, in a natural or computer language. For example text may be received, e.g., as a series of encoded characters, e.g. UTF-8 encoded characters; such “characters” can include Chinese and other similar characters, as well as logograms, syllabograms and the like. A text encoder, i.e. a tokenizer, can process a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also or instead the tokens may represent an image. For example a set (sequence) of input or output tokens can represent an image. Each image token may comprise a block encoding of values of the pixels in a different region of an image that maps a set of values of the pixels to a respective image token. The block encoder may comprise a neural network, e.g. having one or more (self-)attention layers, such as a Transformer neural network.

As used herein an image may be any still or moving image, i.e. the image may be part of a video, in 2D or 3D, and may be a monochrome, color or hyperspectral image, i.e. comprising monochrome or color pixels. As defined herein an “image” includes a point cloud e.g. from a LIDAR system, and a “pixel” includes a point of the point cloud. An image may have been captured by a camera or other image sensor from the real world; and objects in the image may comprise physical objects, represented by the image.

Also or instead the tokens may represent an audio waveform. For example a set (sequence) of input or output tokens can represent audio data representing an waveform e.g. instantaneous audio amplitude values or time-frequency audio data. Each image token may comprise a block encoding of the audio waveform in a different time segment of the audio that maps a set of values representing the audio waveform to a respective image token. The block encoder may comprise a neural network, e.g. having one or more (self-)attention layers, such as a Transformer neural network.

In a multimodal system audio data or an image may be flagged by a start-of-audio token or start-of-image token.

In implementations the tokens represent text, pixels of an image, or an audio waveform and the generative neural network system is configured to generate the output sequence of tokens to perform a task represented by the input sequence of tokens.

In some implementations the task comprises an image or audio generation task. The input sequence of tokens can then characterize the image or audio to be generated, and the output sequence of tokens can comprise tokens defining an image or audio waveform characterized by the input sequence of tokens, e.g. text tokens.

In some implementations the task comprises an image or audio processing task. The input sequence of tokens can define an image or audio input, and the output sequence of tokens can comprise tokens defining text that describes the image or audio input. As some examples, the task can be a speech recognition task, an object or action detection task, a classification task, a captioning task, a question-answering task, or a character or word recognition task.

In some implementations the task comprises a multimodal processing task. One or both of the input sequence of tokens and the input sequence of tokens can comprise multi-modal data. For example the input sequence of tokens can characterize both an image or audio input and a text input and the output sequence of tokens can comprise tokens defining a result of an image or audio processing task defined by the text, such as an open vocabulary classification or object detection task.

In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform.

Some examples of multi-modal tasks include: open-vocabulary image classification (the output can classify the image input based on a text input comprising text descriptions of one or more classes in the image); open-vocabulary object detection (the output can detect one or more objects in the image input based on a text input comprising text descriptions of the one or more objects); image captioning (the output can comprise text that describes the image input); text-based image search (the output can identify from amongst multiple images in the image input one or more images that meet a text description of images to be retrieved, the text description being provided in a text input); image-based retrieval (the output can identify from amongst multiple images in the image input one or more images that match an further image in the image input), and so on. The multi-modal processing task to be performed can be defined by text in the input sequence.

In some implementations the task comprises an agent control task in which the agent interacts with an environment to perform the task. The agent can be a mechanical agent such a robot or (semi-)autonomous vehicle, interacting with a real-world environment to perform the task. The generative neural network system can be trained to control a simulated version of the agent in in a simulated version of the environment and then afterwards used to control the real agent in the real-world environment. The input sequence of tokens can comprise tokens that represent an observation of the environment, e.g. an image captured by a camera or other imaging device from a real-world environment. The output sequence of tokens comprises tokens that define one or more actions to be performed by the agent in the environment in response to the observation.

There are many suitable training datasets available, depending on the task to be performed. Just as some examples these include, for text: WebLI (Web Language Image, Chen et al. arXiv:2305.18565v1). Some examples for images include: the Visual Genome dataset for Visual Question Answering (Krishna et al., arXiv:1602.07332); Objects365 (Shao et al., “Objects365: A large-scale, high-quality dataset for object detection”, IEEE/CVF international conference on computer vision, pages 8430-8439); Open Images V4 (Kuznetsova et al., arXiv:1811.00982); the SBU dataset (Ordonez et al. “Im2Text: Describing Images Using 1 Million Captioned Photographs”, NeurIPS 2011); the Conceptual Captions datasets, e.g. V1 (2M images) or V2 (10M images) (Sharma et al., “Conceptual Captions: A Cleaned, Hypernymed, Image Alt-text Dataset For Automatic Image Captioning”, ACL 2018); and Kinetics for video (Kay et al., arXiv:1705.06950). An example for audio data is AudioSet (Gemmeke et al., “Audio set: An ontology and human-labeled dataset for audio events,” ICASSP, IEEE, 2017, pp. 776-780). An example training dataset for agent (robot) control is described in Ebert et al., arXiv:2109.13396.

In general a training dataset for a particular task may comprise task-specific training examples that have been manually generated by a human being and/or task-specific training data may be generated automatically using existing tools. For example an OCR (Optical Character Recognition) task dataset may be generated by applying an OCR tool to a corpus of images; or an object detection task that requires generating object bounding-box coordinates may be generated by applying an existing object detection tool, such as a trained neural network, to a corpus of images; or a set of aligned image and text representations may be generated using ALIGN (Jia et al., arXiv:2102.05918); or instruction-annotated robot trajectories may be obtained as described in Brohan et al., arXiv:2212.06817, in either the real-world or in simulation.

The neural networks described herein can generally have any appropriate architecture for performing the machine learning task. Examples of neural network architectures that the neural network can have include convolutional architectures, recurrent architectures, fully-connected architecture, e.g., multi-layer perceptron (MLP) architectures, generative (large) language model or multi-modal model architectures, e.g., encoder-only Transformer architectures, encoder-decoder Transformer architectures, decoder-only Transformer architectures, other attention-based architectures, and so on. A Transformer neural network architecture typically comprises one or more Transformer layers or “blocks” each including a self-attention neural network layer followed by a feedforward neural network layer, and often one or more normalization layers.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer implemented method for training a probabilistic energy-based model, the method comprising:
obtaining an energy model configured to parameterize, based on a first set of parameters, an energy function of the probabilistic energy-based model to determine an energy score associated with a combination of an input and an output;
obtaining a normalization neural network configured to parameterize, based on a second set of parameters, a normalization factor of the probabilistic energy-based model; and
jointly training the energy model and the normalization neural network by minimizing a loss function that is dependent on the energy score determined by the energy model and the normalization factor determined by the normalization neural network.

2. The method of claim 1 wherein the normalization neural network parameterises a normalization function that includes a sum or integral of probabilities across output space.

3. The method of claim 1 wherein jointly training the energy model and the normalization neural network is performed through gradient descent.

4. The method of claim 1 wherein jointly training the energy model and the normalization neural network comprises minimizing the loss function with respect to the first set of parameters and the second set of parameters.

5. The method of claim 1 wherein the loss function comprises a first term and a second term, wherein the first term comprises an expectation with respect to inputs and outputs of the energy score output by the energy model, and the second term comprises the expectation with respect to inputs of a normalization term, wherein the normalization term comprises the normalization factor output by the normalization neural network and a sum or integral of probabilities determined using the energy model and normalization neural network according to the probabilistic energy-based model as determined based on output values sampled from a prior measure.

6. The method of claim 1 wherein the loss function [symbol] _{ƒ}(g,τ) is:
$${ℒ}_{f} ( g , τ ) = {𝔼}_{x} [ {L}_{g , τ}^{f} ( x ) ] - {𝔼}_{( x , y )} [ g ( x , y ) ]$$
$$where$$
$${L}_{g , τ}^{f} ( x ) = τ ( x ) + {\sum }_{{y}^{′} ∈ 𝒴} q ( {y}^{′} \vert x ) {f}_{+}^{*} ( ( g ( x , {y}^{′} ) - τ ( x ) )$$
where
g(x,y) is an energy score output by the energy model based on an input x and an output y;
τ(x) is the normalization factor output by the normalization neural network and based on the input x;
q( ) is a prior measure;
y′ is a sampled output that is sampled from output space [symbol] based on the prior measure q(⋅|x) for the input x;
$${f}_{+}^{*} ( )$$
is a convex conjugate of ƒ₊( ) which is the restriction of ƒ( ) to positive real values and
ƒ( ) is a generator function of an f-divergence used to determine a probability distribution according to the probabilistic energy-based model.

7. The method of claim 6 wherein the probability distribution
$${p}_{g}^{f}$$
(⋅|x) according the probabilistic energy-based model is represented by:
$${p}_{g}^{f} ( \cdot \vert x ) = {argmax}_{p ∈ {P}_{1} ( 𝒴 )} 〈 g ( x , \cdot ) , p 〉 - {D}_{f} ( p , q ( \cdot \vert x ) )$$
where
D_{ƒ}(p,q(⋅|x)) is the f-divergence between the prior measure q( ) and a first probability distribution p taken from a space of probability distributions P₁( [symbol] ).

8. The method of claim 6 wherein a probability
$${p}_{g}^{f} ( y \vert x )$$
of the output y based on the input x according to the probabilistic energy-based model is given by:
$${p}_{g}^{f} ( y \vert x ) = q ( y \vert x ) {( {f}_{+}^{*} )}^{′} ( g ( x , y ) - τ ( x ) ) .$$

9. The method of claim 6 wherein the f-divergence is a chi-square divergence and the loss function is a sparsemax loss function.

10. The method of claim 9 wherein
$${L}_{g , τ}^{f} ( x )$$
is given by:
$${L}_{g , τ}^{f} ( x ) = {L}_{g , τ} ( x ) = τ ( x ) + \frac{1}{2} {\sum }_{{y}^{′} ∈ 𝒴} {q ( {y}^{′} \vert x ) [ g ( x , {y}^{′} ) - τ ( x ) ]}_{+}^{2}$$
where [ ]₊ denotes the non-negative part, and
wherein a probability
$${p}_{g}^{f} ( y \vert x )$$
or the output y based on the input x according to the probabilistic energy-based model is given by:
$${p}_{g}^{f} ( y \vert x ) = {q ( y \vert x ) [ g ( x , y ) - τ ( x ) ]}_{+} .$$

11. The method of claim 6 wherein
$${L}_{g , τ}^{f} ( x ) = {L}_{g , τ} ( x ) = τ ( x ) + {\sum }_{{y}^{′} ∈ 𝒴} q ( {y}^{′} \vert x ) ( exp ( g ( x , {y}^{′} ) - τ ( x ) ) - 1 ) .$$

12. The method of claim 11 wherein the probability distribution p_{g}(⋅|x) according to the probabilistic energy-based model is represented by:
$${p}_{g} ( \cdot \vert x ) = {arg max}_{p ∈ {P}_{1} ( 𝒴 )} 〈 g ( x , \cdot ) , p 〉 - K L ( p , q ( \cdot \vert x ) )$$
where
KL(p,q(⋅|x)) is a Kullback-Leibler divergence between the prior measure q( ) and a first probability distribution p taken from a space of probability distributions P₁( [symbol] ).

13. A computer implemented method for predicting a probability of an output based on an input using a probabilistic energy-based model, the method comprising:
obtaining an energy model configured to parameterize, based on a first set of parameters, an energy function of the probabilistic energy-based model to determine an energy score associated with a combination of an input and an output;
obtaining a normalization neural network configured to parameterize, based on a second set of parameters, a normalization factor of the probabilistic energy-based model; and
determining the probability of the output based on the input according to the probabilistic energy-based model, wherein determining the probability comprises:
determining an energy score using the energy model based on the input and the output; and
determining the probability based on the energy score, wherein the probability is normalized using a normalization value obtained from the normalization neural network based on the input.

14. The method of claim 13 wherein the probability
$${p}_{g}^{f} ( y \vert x )$$
of the output y based on the input x according to the probabilistic energy-based model is given by:
$${p}_{g}^{f} ( y \vert x ) = q ( y \vert x ) {( {f}_{+}^{*} )}^{′} ( g ( x , y ) - τ ( x ) )$$
where
g(x,y) is an energy score output by the energy model based on the input x and the output y;
τ(x) is the normalization factor output by the normalization neural network and based on the input x;
q( ) is a prior measure;
$${{f}_{+}^{*} ( )}^{′}$$
is a differential of a convex conjugate of ƒ₊( ), which is the restriction of ƒ( ) to positive real values; and
ƒ( ) is a generator function of an f-divergence used to determine a probability distribution according to the probabilistic energy-based model.

15. The method of claim 14 wherein the probability distribution
$${p}_{g}^{f} ( \cdot \vert x )$$
according the probabilistic energy-based model is represented by:
$${p}_{g}^{f} ( \cdot \vert x ) = {arg max}_{p ∈ {P}_{1} ( 𝒴 )} 〈 g ( x , \cdot ) , p 〉 - {D}_{f} ( p , q ( \cdot \vert x ) )$$
where
D_{ƒ}(p,q(⋅|x)) is the f-divergence between the prior measure q( ) and a first probability distribution p taken from a space of probability distributions P₁( [symbol] ).

16. The method of claim 14 wherein the probability p_{g}(y|x) of the output y based on the input x according to the probabilistic energy-based model is given by:
$${p}_{g} ( y \vert x ) = q ( y \vert x ) exp ( g ( x , y ) - τ ( x ) ) .$$

17. The method of claim 14 wherein the probability p_{g}(y|x) of the output y based on the input x according to the probabilistic energy-based model is given by:
$${p}_{g} ( y \vert x ) = {q ( y \vert x ) [ g ( x , y ) - τ ( x ) ]}_{+} .$$

18. The method of claim 13 further comprising one or both of:
determining a predicted output based on the probability determined according to the probabilistic energy-based model; and
training a further model based on the determined probability, wherein the output is an output from the further model based on the input.

19. A system comprising:
one or more computers; and
one or more storage devices communicatively coupled to the one or more computers, wherein the one or more storage devices store instructions that, when executed by the one or more computers, cause the one or more computers to:
obtain an energy model configured to parameterize, based on a first set of parameters, an energy function of the probabilistic energy-based model to determine an energy score associated with a combination of an input and an output;
obtain a normalization neural network configured to parameterize, based on a second set of parameters, a normalization factor of the probabilistic energy-based model; and
jointly train the energy model and the normalization neural network by minimizing a loss function that is dependent on the energy score determined by the energy model and the normalization factor determined by the normalization neural network.

20. The system of claim 19 wherein the normalization neural network parameterises a normalization function that includes a sum or integral of probabilities across output space.
